(19) United States
(12) Patent Application Publication
(10) Pub. No.: US 2012/0135147 A1
(43) Pub. Date: May 31, 2012

(54) HIGH BUILD LOW TEMPERATURE EXOTHERM EXTRUDABLE MATERIAL

(75) Inventors: Helena Twardowska, Loveland, OH (US); Cameron Giffen, Oriental, NC (US); Louis Paul Schaefer, Trinity, FL (US); Randall Lake, Independence, KY (US)

(73) Assignee: Illinois Tool Works Inc., Glenview, IL (US)

(21) Appl. No.: 13/302,590

(22) Filed: Nov. 22, 2011

Related U.S. Application Data
(60) Provisional application No. 61/417,982, filed on Nov. 30, 2010.

(51) Int. Cl. B05D 7/00; B05D 3/12; B05D 3/00; C08L 75/14; C08L 33/04

(52) U.S. Cl. 427/289; 525/217; 524/523; 427/385.5

(57) ABSTRACT

A high build tooling compound suited for plug building by extrusion process with conventional FRP dispensing equipment is described. The material is based on urethane hybrid and unsaturated polyester resin mixture with additives to provide low shrinkage and low exotherm. The formulation allows building a desired part thicknesses from 0.5 to 3 inches in one application. Methods of making a plug are also described.

### BACKGROUND OF THE INVENTION

The invention relates to a high build tooling compound suited for plug building by an extrusion process using conventional FRP dispensing equipment.

A plug is used to make a mold, for example a mold for a boat hull. The plug is the core around which the walls of the mold are formed. The mold replicates the contours of the plug in reverse.

The plug is made by taking a piece of foam (e.g., polystyrene, or polyurethane foam) in the desired shape and sealing it with a layer of foam sealer. Aluminum honeycomb or other plug building structures can also be used, which would not require a sealer. Then a layer of resin and glass is placed on the foam. The plug formulation is then placed on the resin/glass layer and allowed to cure. The plug formulation is then machined to the appropriate shape (for example, using a Computer Numerical Control (CNC) machine), and the surface sanded. Primer is then applied (typically two layers), and the surface is sanded and buffed.

The plug is then used to make the mold. Gel coat and multiple layers of resin/glass (e.g., about 6-10) are applied to the plug. A coring material is then applied (e.g., about 250 mil thick layer). Several additional layers of resin/glass are then applied to the coring material. The total thickness of the mold is typically in the range of about 0.75 to about 1.5 in, depending on size.

However, materials currently used to make plugs based on unsaturated polyester resins have certain drawbacks. The thickness of the plug formulation layer is limited to about 0.75 to about 1.0 in. in one application. In order to make a thicker layer, one or more additional layers must be deposited and cured. This significantly increases the amount of time it takes to make the plug. In addition, air voids can be formed between layers of the plug formulation and between passes in the same layer. The viscosity of the plug formulation is high enough that the material cannot flow to fill in the spaces, and the voids have to be filled in afterwards. In addition, a special catalyst, a combination of methylethylketone peroxide (MEKP) and cumene hydroperoxide (CHP) in a 1:1 ratio, is required to obtain a low exotherm. The low exotherm is important to prevent the foam from melting while the plug is made. Furthermore, the formulation requires a minimum of 2.5% by weight or 1.75% by volume of catalyst to obtain the proper cure. If the material is under-catalyzed, when the plug is machined, the under-catalyzed shavings can generate heat and cause smoke.

### SUMMARY AND DETAILED DESCRIPTION OF THE INVENTION

The formulation uses a combination of a medium to high reactivity urethane unsaturated polyester hybrid resin and one or more low reactivity unsaturated polyester resins. It provides good impact strength and crack resistance. The parts produced show high Durometer hardness, as well as excellent CNC machinability, producing shavings with no dust. Parts retain their mechanical properties at elevated temperatures. They have a high heat distortion temperature, low shrinkage, a smooth surface appearance, and no microcracking at thicknesses up to 3 inches. The formulation allows building desired part thicknesses from 0.5 to 3 inches in a single application.

The urethane unsaturated polyester hybrid resin (e.g., Dion 31040-00 from Reichhold Inc.) has unique cure characteristics and enhanced mechanical properties, such as high impact strength and toughness. Its use with the low reactivity unsaturated polyester resins allows control of the exotherm at relatively low temperature by extending cure over a longer time period.

The low reactivity unsaturated polyesters are polyester resins having fewer double bonds than typical polyester resins, resulting in less crosslinking. Suitable low reactivity unsaturated polyester resins include, but are not limited to, Polylite 32361-00, and Polylite 31008-00 available from Reichhold Inc. Although not wishing to be bound by theory, it is believed that the urethane unsaturated polyester hybrid resin does not begin to cure until after the low reactivity unsaturated polyesters have at least partially reacted and increased the temperature. The complete reaction takes place over a longer time than with conventional resins, and it does not generate as much heat, which reduces the overall reaction temperature. The lower reaction temperature helps to protect the foam, and reduces the possibility of the foam melting during processing. The highest temperature for the reaction is desirably in the range of about 150-180° F. or less, or about 150-170° F. or less. The lower temperature extends the duration of the exotherm from less than about 10 minutes to about 20 minutes.

There will typically be at least two low reactivity unsaturated polyester resins. The total amount of low reactivity unsaturated polyester resin will generally be between about 20 and 80 wt %. (All percentages are based on the total weight of the tooling compound.) The low reactivity unsaturated polyesters can be isophthalic or orthophthalic polyester resins or combinations. The combination of isophthalic or orthophthalic polyester resins provides high strength, flexibility, and lower cost. When both are present, each one can be present in an amount of between about 10 and about 70 wt %, or about 20 to about 40 wt %, or about 20 to about 35 wt %.

The formulation produces a low exotherm with commonly used methyl ethyl ketone peroxide (MEKP) catalysts; special catalysts are not required. In addition, there is a complete cure at a catalyst level of about 1.5 to about 2 weight % (or about 1.25 to about 1.75 vol %). Therefore, control of the catalyst level is less strict.

The resin mixture can be combined with various additives (e.g., milled fiber glass and acrylic resin) to provide a material having low shrinkage, e.g., less than about 0.3%.

Microspheres are included to reduce the density of the material. Glass, plastic, or ceramic microspheres can be used. However, glass and plastic microspheres are preferred because they have increased weight reduction compared to ceramic microspheres.

Air voids do not form during application using this formulation. Although not wishing to be bound by theory, it is believed that the viscosity of the formulation is low enough that it flows and will fill in spaces between passes in the same layer. The ability to build a 3 inch layer in a single pass means that multiple layers will not be required in almost all cases. However, the lower viscosity would allow flow and fill in if multiple layers are used.

At the same time, the thixotropic index is high enough to ensure good vertical hang at 1″ thickness.

The formulation can be used with different application processes. It can be applied with conventional fiberglass reinforced plastic (FRP) equipment. It can also be applied by hand to build radii and feature lines, if desired.

The formulation has excellent milling and sanding characteristics. It is easy and fast to machine, and produces shavings, not dust. Typically, the plug can be machined after about 4 hours from the beginning of the application of the high build tooling compound. Moreover, because complete cure is obtained at lower catalyst levels, there is no problem of smoking caused by undercured parts.

The formulation bonds to itself and many other substrates, and it is compatible with primers.

Alternatively, this formulation can be used to replace more expensive resin systems presently used for tooling, such as epoxies. It provides faster cure and no need for autoclaving.

Suitable compositions are shown in Table I. Properties for a preferred composition are shown in Table II.

The preferred high build tooling compound shown in column 3 of Table I was catalyzed with MEKP and used to make a plug. The plug was successfully used to make a mold. The plug retained dimensional stability, and no cracking or microcracking was observed after the mold was made. The plug was reused to make two additional molds. It retained good dimensional stability and showed no cracking or microcracking. This demonstrates that the same plug may be used to make multiple molds, e.g., at least three.

If desired, the exotherm can be further reduced by replacing about 1-5% of the resins with monomer. Suitable monomers include, but are not limited to, a-methyl styrene and vinyl toluene. At 2% of a-methyl styrene and 2 weight % MEKP 925, the exotherm was in the range 150-165° F., and the other properties were not changed. This makes formulation less sensitive to the amount of catalyst, and thus more robust.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

TABLE I
High Build Low Tg Tooling Compound

| | Typical | Preferred | Preferred |
|---|---|---|---|
| Component | weight % | weight % | weight % |
| Urethane hybrid (Dion 31040-00) | 5-25 | 10-17 | 13.7 |
| UPE iso resin | 0-80 | 21-33 | 25.9 |
| UPE ortho resin | 0-80 | 23-35 | 28.2 |
| Monomer | 0-5 | 1-3 | 2 |
| Acrylic resin | 0-25 | 0-10 | 5 |
| Activators | up to 3 | up to 1 | 0.25 |
| Inhibitors | up to 3 | up to 1 | 0.22 |
| Fumed silica | 0-20 | 0-10 | 5.4 |
| Milled fiber glass | 0-20 | 1-10 | 4.8 |
| Plastic bubbles | 0-25 | 0.5-10 | 0.56 |
| Glass Microspheres | 0-25 | 1-25 | 13.9 |
| Total | | | 100 |

TABLE II
General Properties of High Build Tooling Compound

| No. | Property | | |
|---|---|---|---|
| 1 | Color | off white | |
| 2 | Styrene content | 21-25% | |
| 3 | Catalyst | MEKP | |
| 4 | Mix ratio | 100:1.5 | |
| 5 | Viscosity, T-F@20 rpm 98.6 F. | 250-300K | |
| 6 | Viscosity, T-F@20 rpm RT | 300-350K | |
| 7 | Thixotropic Index | 6.0-7.0 | |
| 8 | Wt/gal | 6.8-7.1 | |
| 9 | Gel time, 100 g + 2% MEKP@RT | 45-60 | min |
| 10 | Peak Exotherm, 100 g + 2% MEKP, RT | 150-180° | F. |
| 11 | Time to Peak Exotherm (2% MEKP) | 100-120 | min |
| 12 | HDT | 122 | F. |
| 13 | Hardness after 24 hrs at RT | 65-75 | Shore D |
| 14 | Shrinkage | <0.5% | |
| 15 | Equipment | pumpable | |
| 16 | Vertical hang | up to 1″ | |
| 17 | WFT/DFT per pass | 750-1000 | mils |

What is claimed is:

1. A high build tooling compound comprising:
a urethane unsaturated polyester hybrid resin;
a low reactivity unsaturated polyester resin; and
optionally one or more of monomer, acrylic resin, activators, inhibitors, fumed silica, fiber glass, microspheres, or catalyst.

2. The high build tooling compound of claim 1 wherein the urethane unsaturated polyester hybrid resin is present in an amount of about 5 to about 25 wt %; and the low reactivity unsaturated polyester resin present in an amount of about 20 to about 80 wt %.

3. The high build tooling compound of claim 1 wherein the low reactivity unsaturated polyester resin is isophthalic unsaturated polyester resin, orthophthalic unsaturated polyester resin, or combinations thereof.

4. The high build tooling compound of claim 3 wherein the isophthalic unsaturated polyester resin is present in an amount of about 10 to about 70 wt % and the orthophthalic unsaturated polyester resin is present in an amount of about 10 to about 70 wt %.

5. The high build tooling compound of claim 1 consisting essentially of:
about 5 to about 25 wt % urethane unsaturated polyester hybrid resin;
about 20 to about 80 wt % low reactivity unsaturated polyester resin;
0 to about 5 wt % monomer;
0 to about 25 wt % acrylic resin;
0 to about 3 wt % activators;
0 to about 3 wt % inhibitors;
0 to about 20 wt % fumed silica;
0 to about 20 wt % milled fiber glass;
0 to about 25 wt % plastic microspheres;
0 to about 25 wt % microspheres; and
optionally a catalyst.

6. The high build tooling compound of claim 5 wherein the low reactivity unsaturated polyester resin is isophthalic unsaturated polyester resin, orthophthalic unsaturated polyester resin, or combinations thereof.

7. The high build tooling compound of claim 6 wherein there is about 20 to about 40 wt % isophthalic unsaturated polyester resin, and about 20 to about 40 wt % orthophthalic unsaturated polyester resin.

8. The high build tooling compound of claim 5 wherein the high build tooling compound consists essentially of.
about 10 to about 20 wt % urethane unsaturated polyester hybrid resin;
about 40 to about 70 wt % low reactivity unsaturated polyester resin;
0 to about 3 wt % monomer;
0 to about 10 wt % acrylic resin;
0 to about 1 wt % activators;
0 to about 1 wt % inhibitors;
0 to about 10 wt % fumed silica;
0 to about 10 wt % milled fiber glass;
0 to about 10 wt % plastic microspheres;
about 1 to about 25 wt % microspheres; and
optionally a catalyst.

9. The high build tooling compound of claim 5 wherein the high build tooling compound consists essentially of:
about 10 to about 20 wt % urethane unsaturated polyester hybrid resin;
about 20 to about 40 wt % low reactivity isophthalic unsaturated polyester resin;
about 20 to about 40 wt % low reactivity orthophthalic unsaturated polyester resin;
0 to about 3 wt % monomer;
0 to about 10 wt % acrylic resin;
0 to about 1 wt % activators;
0 to about 1 wt % inhibitors;
0 to about 10 wt % fumed silica;
0 to about 10 wt % milled fiber glass;
0 to about 10 wt % plastic microspheres;
about 1 to about 25 wt % microspheres; and
optionally a catalyst.

10. The high build tooling compound of claim 1 wherein the catalyst is methyl ethyl ketone peroxide.

11. A method of making a plug comprising
providing a substrate;
placing a layer of resin and glass on the substrate;
applying a layer of a high build tooling compound on the layer of resin and glass, the high build tooling compound comprising:
a urethane unsaturated polyester hybrid resin;
a low reactivity unsaturated polyester resin; and
optionally one or more of monomer, acrylic resin, activators, inhibitors, fumed silica, fiber glass, microspheres, or catalyst curing the layer of the high build tooling compound;
machining the layer of the high build tooling compound; and
applying a primer to the machined layer of the high build tooling compound.

12. The method of claim 11 wherein the substrate is foam and further comprising sealing the foam with a foam sealer before placing the layer of resin and glass on the substrate.

13. The method of claim 11 further comprising sanding the machined layer of the high build plug composition before applying the primer.

14. The method of claim 11 further comprising sanding the machined layer of the high build plug composition after applying the primer.

15. The method of claim 11 wherein the urethane unsaturated polyester hybrid resin is present in an amount of about 5 to about 25 wt %; and the low reactivity unsaturated polyester resin present in an amount of about 20 to about 80 wt % and wherein the low reactivity unsaturated polyester resin is isophthalic unsaturated polyester resin, orthophthalic unsaturated polyester resin, or combinations thereof.

16. The method of claim 11 wherein the high build tooling compound consists essentially of:
about 5 to about 25 wt % urethane unsaturated polyester hybrid resin;
about 20 to about 80 wt % low reactivity unsaturated polyester resin;
0 to about 5 wt % monomer;
0 to about 25 wt % acrylic resin;
0 to about 5 wt % activators;
0 to about 5 wt % inhibitors;
0 to about 20 wt % fumed silica;
0 to about 20 wt % milled fiber glass;
0 to about 25 wt % plastic microspheres;
0 to about 25 wt % microspheres; and
a catalyst;

17. The method of claim 16 wherein the low reactivity unsaturated polyester resin is selected from isophthalic unsaturated polyester resin, orthophthalic unsaturated polyester resin, and combinations thereof.

18. The method of claim 17 wherein there is about 20 to about 40 wt % isophthalic unsaturated polyester resin, and about 20 to about 40 wt % orthophthalic unsaturated polyester resin.

19. The method of claim 11 wherein the high build tooling compound consists essentially of:
about 10 to about 20 wt % urethane unsaturated polyester hybrid resin;
about 20 to about 40 wt % low reactivity isophthalic unsaturated polyester resin;
about 20 to about 40 wt % low reactivity orthophthalic unsaturated polyester resin;
0 to about 3 wt % monomer;
0 to about 10 wt % acrylic resin;
0 to about 3 wt % activators;
0 to about 3 wt % inhibitors;
0 to about 10 wt % fumed silica;
0 to about 10 wt % milled fiber glass;
0 to about 10 wt % plastic microspheres;
about 1 to about 25 wt % microspheres; and
a catalyst.

20. The method of claim 11 wherein the catalyst is methyl ethyl ketone peroxide.
